(19) United States
(12) Patent Application Publication
(10) Pub. No.: US 2015/0236824 A1
(43) Pub. Date: Aug. 20, 2015

(54) UPLINK DOWNLINK ASSIGNMENT INDICATOR AMBIGUITY HANDLING FOR INTER-BAND TIME DIVISION DUPLEX CARRIER AGGREGATION

(71) Applicant: Nokia Corporation, Espoo (FI)

(72) Inventors: Haipeng Lei, Beijing (CN); Chunhai Yao, Beijing (CN); Li Zhang, Beijing (CN)

(21) Appl. No.: 14/415,772

(22) PCT Filed: Sep. 28, 2012
(86) PCT No.: PCT/CN2012/082264

§ 371 Date: Jan. 20, 2015

(51) Int. Cl. H04L 1/18; H04W 72/04; H04L 5/14

(52) U.S. Cl. CPC H04L 1/1861; H04L 5/14; H04W 72/042

(57) ABSTRACT

Various communication systems may benefit from techniques for handling inter-band carrier aggregation. For example, systems of the third generation partnership project (3 GPP) long term evolution (LTE) advanced (LTE-A) may benefit from an uplink (UL) downlink assignment indicator (DAI) ambiguity handling or inter-band time division duplex (TDD) carrier aggregation (CA). A method can include scheduling physical uplink shared channel in at least one primary cell and at least one secondary cell in a same subframe and granting a different uplink grant to the at least one primary cell and the at least one secondary cell. The method can alternatively include scheduling physical uplink shared channel in at least one serving cell in a subframe with uplink grant and scheduling physical downlink channel in at least another serving cell in following subframe. The method can also include avoiding codebook size confusion by handling uplink downlink assignment indicator ambiguity.

### BACKGROUND

1. Field

Various communication systems may benefit from techniques for handling inter-band carrier aggregation. For example, systems of the third generation partnership project (3GPP) long term evolution (LTE) advanced (LTE-A) may benefit from a uplink (UL) downlink assignment indicator (DAI) ambiguity handling or inter-band time division duplex (TDD) carrier aggregation (CA).

2. Description of the Related Art

In LTE release 10 (Rel-10), up to five component carriers with same time division duplex uplink/downlink (UL/DL) configurations can be supported in carrier aggregation. In LTE Rel-11, inter-band time division duplex carrier aggregation with different time division duplex uplink/downlink configurations on different bands may further enhance carrier aggregation.

Inter-band carrier aggregation of time division duplex component carriers (CCs) with different uplink/downlink configurations include characteristics such as co-existence with the neighboring legacy time division duplex system; support of aggregation of traffic-dependent carriers in heterogeneous networks; flexible configuration, for example, more uplink subframe in lower frequency band for better coverage and more downlink subframes in high frequency band for traffic transmission; and higher peak data rate.

Currently, LTE time division duplex allows for asymmetric uplink-downlink allocations by providing seven different time division duplex uplink-downlink configurations shown in FIG. 1. These configurations can provide between 40% and 90% downlink subframes. If different time division duplex uplink-downlink configurations on different bands are specified, the user equipment (UEs) will be informed of the actual time division duplex uplink/downlink configuration of each aggregated component carrier. In FIG. 1, D corresponds to a downlink subframe, U corresponds to an uplink subframe, and S corresponds to a special subframe.

### SUMMARY

According to a first embodiment, a method includes scheduling physical uplink shared channel in at least one primary cell and at least one secondary cell in a same subframe and granting a different uplink grant to the at least one primary cell and the at least one secondary cell. The method alternatively includes scheduling physical uplink shared channel in at least one serving cell in a subframe with uplink grant and scheduling physical downlink channel in at least another serving cell in following subframe. The method also includes avoiding codebook size confusion by handling uplink downlink assignment indicator ambiguity.

According to a second embodiment, a method includes generating hybrid automatic-repeat request acknowledgment bits to be transmitted on a physical uplink shared channel scheduled by UL grant containing UL DAI. The method also includes determining the number of subframes for which the user equipment needs to feed back hybrid automatic-repeat request acknowledgment bits for a given serving cell as the number of downlink elements in a downlink association set according to followed downlink reference uplink-downlink configuration for the given serving cell. The method further includes transmitting the acknowledgement bits based on the determining.

According to a third embodiment, a method includes generating hybrid automatic-repeat request acknowledgment bits to be transmitted on a physical uplink shared channel scheduled by UL grant containing UL DAI. The method also includes determining whether the given sub frame yields is ambiguous when uplink downlink assignment indicator is followed, wherein the determining the number of sub frames UE needs to feedback hybrid automatic-repeat request acknowledgment bits as the number of the downlink elements in the downlink association set is performed when following the uplink downlink assignment indicator would yield ambiguity. The method further includes transmitting the acknowledgement bits based on the determining.

According to a fourth embodiment, a method includes generating an uplink downlink assignment indicator. The method also includes calculating the uplink downlink assignment indicator according to the number of downlink elements in a downlink association set according to followed downlink reference uplink-downlink configurations among serving cells.

According to a fifth embodiment, a method includes receiving an uplink downlink assignment indicator, and the downlink reference uplink-downlink configuration of none of the serving cells is uplink-downlink configuration number five. The method also includes determining the number of subframes UE needs to feedback hybrid automatic-repeat request acknowledgment bits on serving cell based on user equipment received physical downlink shared channel and SPS-releasing PDCCH, uplink downlink assignment indicator, and the number of the downlink elements in the downlink association set.

According to a sixth embodiment, a method includes receiving a schedule for physical uplink shared channel in at least one primary cell and at least one secondary cell in a same subframe and receiving a different uplink grant to the at least one primary cell and the at least one secondary cell. The method alternatively includes receiving physical uplink shared channel in at least one serving cell in a subframe with uplink grant and receiving physical uplink shared channel in at least another serving cell in following subframe. The method also includes determining a codebook size with respect to an uplink downlink assignment indicator.

According to a seventh embodiment, an apparatus includes at least one processor and at least one memory including computer program code. The at least one memory and the computer program code are configured to, with the at least one processor, cause the apparatus at least to schedule physical uplink shared channel in at least one primary cell and at least one secondary cell in a same subframe and granting a different uplink grant to the at least one primary cell and the at least one secondary cell. The at least one memory and the computer program code are alternatively configured to, with the at least one processor, cause the apparatus at least to schedule physical uplink shared channel in at least one serving cell in a subframe with uplink grant and scheduling physical downlink channel in at least another serving cell in following subframe. The at least one memory and the computer program code are also configured to, with the at least one processor, cause the apparatus at least to avoid codebook size confusion by handling uplink downlink assignment indicator ambiguity.

According to an eighth embodiment, an apparatus includes at least one processor and at least one memory including computer program code. The at least one memory and the computer program code are configured to, with the at least one processor, cause the apparatus at least to generate hybrid automatic-repeat request acknowledgment bits to be transmitted on a physical uplink shared channel scheduled by UL grant containing UL DAI. The at least one memory and the computer program code are also configured to, with the at least one processor, cause the apparatus at least to determine the number of subframes for which the user equipment needs to feed back hybrid automatic-repeat request acknowledgment bits for a given serving cell as the number of downlink elements in a downlink association set according to followed downlink reference uplink-downlink configuration for the given serving cell. The at least one memory and the computer program code are further configured to, with the at least one processor, cause the apparatus at least to transmit the acknowledgement bits based on the determining.

According to a ninth embodiment, an apparatus includes at least one processor and at least one memory including computer program code. The at least one memory and the computer program code are configured to, with the at least one processor, cause the apparatus at least to generate hybrid automatic-repeat request acknowledgment bits to be transmitted on a physical uplink shared channel scheduled by UL grant containing UL DAI. The at least one memory and the computer program code are also configured to, with the at least one processor, cause the apparatus at least to determine whether the given subframe yields is ambiguous when uplink downlink assignment indicator is followed, wherein determination of the number of subframes UE needs to feedback hybrid automatic-repeat request acknowledgment bits as the number of the downlink elements in the downlink association set is performed when following the uplink downlink assignment indicator would yield ambiguity. The at least one memory and the computer program code are further configured to, with the at least one processor, cause the apparatus at least to transmit the acknowledgement bits based on the determining.

According to a tenth embodiment, an apparatus includes at least one processor and at least one memory including computer program code. The at least one memory and the computer program code are configured to, with the at least one processor, cause the apparatus at least to generate an uplink downlink assignment indicator. The at least one memory and the computer program code are also configured to, with the at least one processor, cause the apparatus at least to calculate the uplink downlink assignment indicator according to the number of downlink elements in a downlink association set according to followed downlink reference uplink-downlink configurations among serving cells.

According to an eleventh embodiment, an apparatus includes at least one processor and at least one memory including computer program code. The at least one memory and the computer program code are configured to, with the at least one processor, cause the apparatus at least to receive an uplink downlink assignment indicator, and the downlink reference uplink-downlink configuration of none of the serving cells is uplink-downlink configuration number five. The at least one memory and the computer program code are configured to, with the at least one processor, cause the apparatus at least to determine the number of subframes UE needs to feedback hybrid automatic-repeat request acknowledgment bits on serving cell based on user equipment received physical downlink shared channel and SPS-releasing PDCCH, uplink downlink assignment indicator, and the number of the downlink elements in the downlink association set.

According to a twelfth embodiment, an apparatus includes at least one processor and at least one memory including computer program code. The at least one memory and the computer program code are configured to, with the at least one processor, cause the apparatus at least to receive a schedule for physical uplink shared channel in at least one primary cell and at least one secondary cell in a same subframe and receive a different uplink grant to the at least one primary cell and the at least one secondary cell. The at least one memory and the computer program code are alternatively configured to, with the at least one processor, cause the apparatus at least to receive physical uplink shared channel in at least one serving cell in a subframe with uplink grant and receive physical uplink shared channel in at least another serving cell in following subframe. The at least one memory and the computer program code are also configured to, with the at least one processor, cause the apparatus at least to determine a codebook size with respect to an uplink downlink assignment indicator.

According to a thirteenth embodiment, an apparatus includes scheduling means for scheduling physical uplink shared channel in at least one primary cell and at least one secondary cell in a same subframe and granting a different uplink grant to the at least one primary cell and the at least one secondary cell. Alternatively, the apparatus includes scheduling means for scheduling physical uplink shared channel in at least one serving cell in a subframe with uplink grant and scheduling physical downlink channel in at least another serving cell in following subframe. The apparatus also includes handling means for avoiding codebook size confusion by handling uplink downlink assignment indicator ambiguity.

According to a fourteenth embodiment, an apparatus includes generating means for generating hybrid automatic-repeat request acknowledgment bits to be transmitted on a physical uplink shared channel scheduled by UL grant containing UL DAT. The apparatus also includes determining means for determining the number of subframes for which the user equipment needs to feed back hybrid automatic-repeat request acknowledgment bits for a given serving cell as the number of downlink elements in a downlink association set according to followed downlink reference uplink-downlink configuration for the given serving cell. The apparatus further includes transmitting means for transmitting the acknowledgement bits based on the determining.

According to a fifteenth embodiment, an apparatus includes generating means for generating hybrid automatic-repeat request acknowledgment bits to be transmitted on a physical uplink shared channel scheduled by UL grant containing UL DAT. The apparatus also includes determining means for determining whether the given subframe yields is ambiguous when uplink downlink assignment indicator is followed, wherein the determining the number of subframes UE needs to feedback hybrid automatic-repeat request acknowledgment bits as the number of the downlink elements in the downlink association set is performed when following the uplink downlink assignment indicator would yield ambiguity. The apparatus further includes transmitting means for transmitting the acknowledgement bits based on the determining.

According to a sixteenth embodiment, an apparatus includes generating means for generating an uplink downlink assignment indicator. The apparatus also includes calculating means for calculating the uplink downlink assignment indicator according to the number of downlink elements in a downlink association set according to followed downlink reference uplink-downlink configurations among serving cells.

According to a seventeenth embodiment, an apparatus includes receiving means for receiving an uplink downlink assignment indicator, and the downlink reference uplink-downlink configuration of none of the serving cells is uplink-downlink configuration number five. The apparatus also includes determining means for determining the number of subframes UE needs to feedback hybrid automatic-repeat request acknowledgment bits on serving cell based on user equipment received physical downlink shared channel and SPS-releasing PDCCH, uplink downlink assignment indicator, and the number is of the downlink elements in the downlink association set.

According to an eighteenth embodiment, an apparatus includes receiving means for receiving a schedule for physical uplink shared channel in at least one primary cell and at least one secondary cell in a same subframe and receiving a different uplink grant to the at least one primary cell and the at least one secondary cell. Alternatively, the apparatus includes receiving means for receiving physical uplink shared channel in at least one serving cell in a subframe with uplink grant and receiving physical uplink shared channel in at least another serving cell in following subframe. The apparatus also includes determining means for determining a codebook size with respect to an uplink downlink assignment indicator.

According to nineteenth through twenty-fourth embodiments, a non-transitory computer readable medium encoded with instructions that, when executed in hardware, perform a process, the process comprising the method according to respectively the first through the sixth embodiments.

### BRIEF DESCRIPTION OF THE DRAWINGS

For proper understanding of the invention, reference should be made to the accompanying drawings, wherein:

FIG. 1 illustrates seven kinds of time division duplex uplink/downlink configurations.

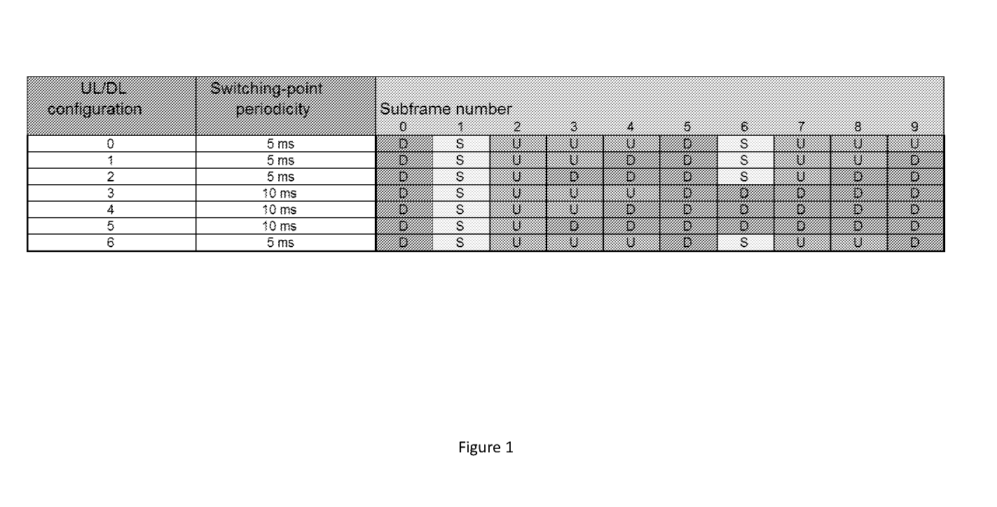

FIG. 2 illustrates inter-band time division duplex carrier aggregation with Pcell in configuration #1, Scell configuration #5.

FIG. 3 illustrates different uplink downlink assignment indicator values in case of multiple uplink grants scheduling multiple physical uplink shared channel, according to certain embodiments.

FIG. 4 illustrates methods according to certain embodiments.

FIG. 5 illustrates a system according to certain embodiments of the invention.

FIG. 6 illustrates another method according to certain embodiments.

FIG. 7 illustrates a further method according to certain embodiments.

FIG. 8 illustrates an additional method according to certain embodiments.

FIG. 9 illustrates another method according to certain embodiments.

FIG. 10 illustrates yet another method according to certain embodiments.

### DETAILED DESCRIPTION

LTE time division duplex is typically operated as a downlink heavy system, which results in a uplink subframe usually used to transmit hybrid automatic repeat request (HARQ) acknowledgments (HARQ-ACKs) corresponding to multiple downlink subframes. As specified in 3GPP technical specification (TS) 36.213, which is hereby incorporated herein by reference in its entirety, the set of downlink subframes whose HARQ-ACKs are reported in the same uplink subframe is listed in Table 1.

TABLE 1
Downlink association set index K: {k₀, k₁, . . . k_{M-1}} for time
division duplex.

| UL-DL | | | | | | | | | | |
|---|---|---|---|---|---|---|---|---|---|---|
| Config- | Subframe n | | | | | | | | | |
| uration | 0 | 1 | 2 | 3 | 4 | 5 | 6 | 7 | 8 | 9 |
| 0 | — | — | 6 | — | 4 | — | — | 6 | — | 4 |
| 1 | — | — | 7, 6 | 4 | — | — | — | 7, 6 | 4 | — |
| 2 | — | — | 8, 7, 4, 6 | — | — | — | — | 8, 7, | — | — |
| | | | | | | | | 4, 6 | | |
| 3 | — | — | 7, 6, 11 | 6, 5 | 5, 4 | — | — | — | — | — |
| 4 | — | — | 12, 8, 7, 11 | 6, 5, | — | — | — | — | — | — |
| | | | | 4, 7 | | | | | | |
| 5 | — | — | 13, 12, 9, 8, | — | — | — | — | — | — | — |
| | | | 7, 5, 4, 11, 6 | | | | | | | |
| 6 | — | — | 7 | 7 | 5 | — | — | 7 | 7 | — |

Primary cell (Pcell) physical downlink shared channel (PDSCH) HARQ timing can follow its own uplink/downlink configuration timing. According to the different configurations from Pcell and secondary cell(s) (Scell(s)), Scell PDSCH HARQ timing will a reference uplink/downlink configuration as shown in below table, 3 different cases are identified as follows in Table 1, in case A Scell(s) downlink subframes are a subset of Pcell; in case B Scell(s) downlink subframes are a superset of Pcell; and in case C Scell(s) downlink subframes are neither a superset nor a subset of Pcell.

TABLE 2
Scell PDSCH HARQ-ACK reference timing in case of
self-scheduling

| PDSCH HARQ timing | | | | | | | | |
|---|---|---|---|---|---|---|---|---|
| on Scell follows TDD | | Pcell SIB-1 UL-DL Configuration | | | | | | |
| UL-DL configuration # | | 0 | 1 | 2 | 3 | 4 | 5 | 6 |
| Scell SIB-1 | 0 | | 1 | 2 | 3 | 4 | 5 | 6 |
| UL-DL | 1 | 1 | | 2 | 4 | 4 | 5 | 1 |
| Configuration | 2 | 2 | 2 | | 5 | 5 | 5 | 2 |
| | 3 | 3 | 4 | 5 | | 4 | 5 | 3 |
| | 4 | 4 | 4 | 5 | 4 | | 5 | 4 |
| | 5 | 5 | 5 | 5 | 5 | 5 | | 5 |
| | 6 | 6 | 1 | 2 | 3 | 4 | 5 | |

| | | | |
|---|---|---|---|
| Notes: The number in the | Case A | Case B | Case C |
| grid is the reference | | | |
| UL-DL configuration | | | |
| which Scell PDSCH | | | |
| HARQ timing follows. | | | |

The following characteristics may be present for a user equipment (UE) configured with physical uplink control channel (PUCCH) format 3 for HARQ-ACK transmission and at least self-carrier scheduling: whether uplink index or downlink assignment indicator exists in downlink control information (DCI) format 0/4 scheduling PUSCH on serving cell c can be determined based on the PUSCH HARQ timing reference configuration on serving cell c; for HARQ-ACK transmission in an uplink subframe n and on PUCCH or on PUSCH not adjusted by an uplink grant, or on the PUSCH adjusted by its associated uplink grant without W_{DAI}̂{UL}, Bĉ{DL}=Mc where Mc is the number of elements in set Kc; for HARQ-ACK transmission in an uplink subframe n and on the PUSCH adjusted by its associated uplink grant with W_{DAI}̂{UL}, Bĉ{DL}=min(W_{DAI}̂{UL}, Mc) if none of the timing reference configurations of aggregated serving cells is configuration #5; and for HARQ-ACK transmission in an uplink subframe n and on the PUSCH adjusted by its associated uplink grant with W_{DAI}̂{UL}, Bĉ{DL}=min(W_{DAI}̂{UL}+4ceil((U−W_{DAI}̂{UL})/4), Mc) if the timing reference configuration of any aggregated serving cell is configuration #5.

The following characteristics may be present for a user equipment configured with PUCCH format 1b with channel selection for HARQ-ACK transmission and self-carrier scheduling. The HARQ-ACK transmission can follow the Rel-10 design except the following: configuration #5 is applicable if none of the PDSCH timing reference configurations of aggregated serving cells; the set of downlink subframes (denoted as Kc) on serving cell c associated with uplink subframe n shall include the downlink subframes n-k where kεK and K is determined according to the time division duplex uplink-downlink configuration which the PDSCH HARQ timing on serving cell c follows; and for HARQ-ACK transmission on PUCCH (at least for the case when all Mp, Ms are positive) the user equipment can use the Rel-10 mapping table with M=max{Mp, Ms}, where Mp is the number of elements in set Kc for the primary cell and Ms is the number of elements in set Kc for the secondary cell and the user equipment shall set discontinuous transmission (DTX) for {HARQ-ACK(min{Mp, Ms}), . . . , HARQ-ACK(M−1)} for the serving cell with the smaller Mc value.

In that sense, the HARQ timing reference for a Scell can be different from Pcell time division duplex uplink/downlink configuration. As a result, the HARQ-ACK transmission methods defined in Rel-10 assuming Pcell timing for all configured carriers are problematic.

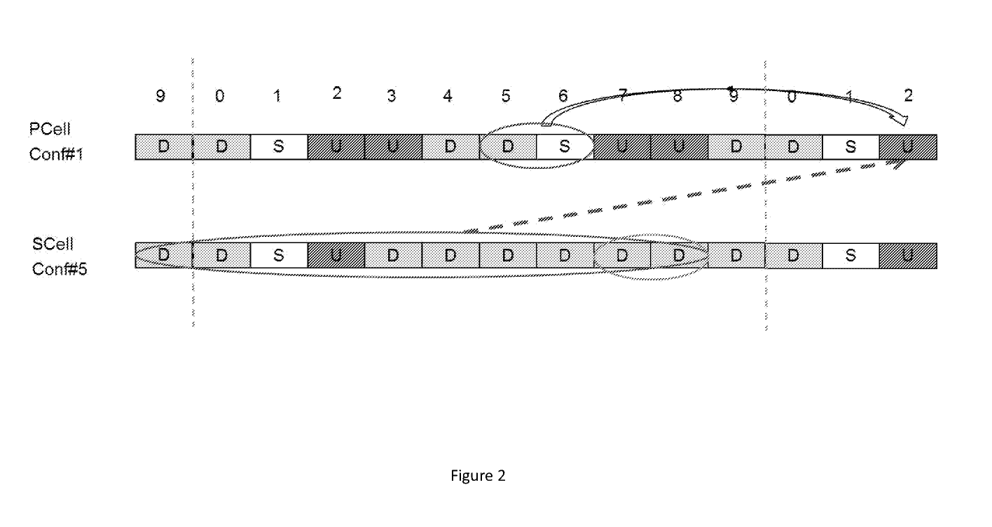

FIG. 2 illustrates inter-band time division duplex carrier aggregation with Pcell in configuration #1, Scell configuration #5.

A first problem may be related to uplink downlink assignment indicator value setting at an evolved Node B (eNB) and interpretation of uplink downlink assignment indicator at user equipment. As shown in FIG. 2, two carriers on different bands with different time division duplex uplink/downlink configurations are aggregated. Pcell is configured with time division duplex uplink/downlink configuration 1 and S cell with time division duplex uplink/downlink configuration 5. Therefore, the set of downlink subframes on Scell is a superset of the downlink subframes on Pcell. PDSCH HARQ timing for Pcell PDSCH follows time division duplex uplink/downlink configuration 1, while PDSCH HARQ timing reference for the Scell in case of self-scheduling follows time division duplex uplink/downlink configuration 5.

Therefore, according to the ACK/NACK transmission timing specified in Table 1, ACK/NACK corresponding to downlink subframe 5 and 6 in Pcell are transmitted in uplink subframe 2 in Pcell to follow the HARQ timing of time division duplex uplink/downlink configuration 1. Meanwhile, ACK/NACK corresponding to downlink sub frame 9 (in previous frame) and downlink subframe 0 to 8 (in current frame) in Scell are transmitted in uplink subframe 2 (in next frame) in Pcell to follow the HARQ timing of time division duplex uplink/downlink configuration 5. When these ACK/NACK bits are transmitted by PUSCH in uplink subframe 2 in Pcell and this PUSCH is adjusted based on a detected PDCCH with downlink control information format 0/4, this downlink control information format 0/4 are sent in downlink subframe 6 in Pcell following Pcell PUSCH transmission timing.

In this way, eNB cannot know whether Scell downlink subframe 7 and 8 (identified by an ellipse) will be scheduled or not due to uplink grant timing in Pcell prior to these two subframes possibly scheduled in Scell in time domain. If eNB still sends the downlink assignment indicator in downlink control information format 0/4 according to the maximum scheduled downlink subframes across the two carriers without the consideration of downlink subframe 7 and 8 possibly to be scheduled in Scell, user equipment can get a wrong uplink downlink assignment indicator when downlink subframe 7 and 8 in Scell are scheduled. Since uplink downlink assignment indicator is used to determine the codebook size of HARQ-ACK transmission, an error in uplink downlink assignment indicator will lead to misunderstanding on ACK/NACK feedback between eNB and user equipment.

Table 3 lists all the possible Pcell and Scell uplink-downlink configuration combinations, and identifies the combinations that will conventionally cause codebook size misunderstanding between eNB and user equipment when uplink downlink assignment indicator is used to determine HARQ-ACK codebook size. It can be seen the codebook size misunderstanding will occur in several subframes and in many Pcell and Scell reference uplink-downlink configuration combinations.

TABLE 3
Uplink downlink assignment indicator confusion Pcell and Scell pair

| Pcell and | | | | | | | | | | | |
|---|---|---|---|---|---|---|---|---|---|---|---|
| Scell UL-DL | | | | | | | | | | | |
| Configuration | | | | | | | | | | | |
| Pair (Pcell, | Subframe n | | | | | | | | | | |
| Scell) | 0 | 1 | 2 | 3 | 4 | 5 | 6 | 7 | 8 | 9 | Not OK pairs |
| Pcell = 0 | x | x | (0, 1), (0, 2), | OK | (0, 6) | x | x | (0, 2), (0, 6) | OK | OK | (0, 1), (0, 2), |
| | | | (0, 3), | | | | | | | | (0, 3), (0, 5), (0, 6) |
| | | | (0, 5) | | | | | | | | |
| 1 | x | x | (1, 0), (1, 2), | −(1, 6) | OK | x | x | (1, 2), (1, 6) | −(1, 6) | OK | (1, 0), (1, 2), |
| | | | (1, 5), | | | | | | | | (1, 5), (1, 6) |
| | | | (1, 6) | | | | | | | | |
| 2 | x | x | (2, 0), (2, 1), | OK | OK | x | x | (2, 0), | OK | OK | (2, 0), (2, 1), |
| | | | (2, 6) | | | | | (2, 1), (2, 6) | | | (2, 6) |
| 3 | x | x | (3, 0), (3, 6) | (3, 6) | (3, 6) | x | x | OK | OK | OK | (3, 0), (3, 6) |
| 4 | x | x | OK | (4, 6) | OK | x | x | OK | OK | OK | (4, 6) |
| 5 | x | x | (5, 0), (5, 1), | OK | OK | x | x | OK | OK | OK | (5, 0), (5, 1), |
| | | | (5, 6) | | | | | | | | (5, 6) |
| 6 | x | x | (6, 1), (6, 2), | (6, 1), (6, 3), | (6, 0), (6, 3) | x | x | (6, 0), (6, 1), | (6, 1) | OK | (6, 0), (6, 1), (6, 2), |
| | | | (6, 3), (6, 5) | (6, 4) | | | | (6, 2) | | | (6, 3), (6, 4), |
| | | | | | | | | | | | (6, 5) |

In Table 3, “OK” means there is no codebook size confusion issue if a conventional approach is used. Likewise, in Table 3 “x” means the subframe is always a downlink subframe in all the uplink-downlink configurations.

As can be seen, different PDSCH HARQ reference timings may be used for inter-band time division duplex carrier aggregation with different time division duplex uplink/downlink configurations. The resulting different bundle window size may lead to new issues with respect to uplink downlink assignment indicator when HARQ-ACK is transmitted on PUSCH adjusted by downlink control information format 0/4. Since the codebook size is determined by uplink downlink assignment indicator, this issue will cause the misunderstanding on ACK/NACK transmission between eNB and user equipment. Downlink performance will be degraded.

A second problem is related to multiple uplink grant with different uplink downlink assignment indicator values. That is, if there are multiple PUSCH scheduled to the same uplink subframe with uplink grant transmitted from different downlink subframes, one challenge is how to use the multiple uplink downlink assignment indicator values to determine the codebook size for HARQ-ACK on PUSCH. In the example in FIG. 2, two PUSCH may be scheduled in subframe 2, one on Pcell with uplink grant transmitted in subframe 6 on Pcell, the other on Scell with uplink grant transmitted in subframe 8 on Scell. The two uplink grants may be with different uplink downlink assignment indicator values, and there is no conventional explanation as to how the user equipment should determine the codebook size with different uplink downlink assignment indicator values has not been specified yet.

A third problem relates to Kc, which is used to determine HARQ-ACK codebook size for feedback in PUCCH format 3 and PUCCH format 1b with channel selection. Currently the Kc definition is that the set of downlink subframes (denoted as Kc) on serving cell c associated with uplink subframe n includes the downlink subframes n-k where kεK and K is determined according to the time division duplex uplink-downlink configuration which the PDSCH HARQ timing on serving cell c follows.

According to the definition, Kc is a downlink subframe set and this downlink subframe set is associated with uplink subframe n. However, in some Pcell and Scell uplink-downlink configuration combinations, the associated uplink subframe n is a downlink subframe for one serving cell. So according to current Kc definition, user equipment does not know how to feedback HARQ-ACK bit for that serving cell. For instance, if serving cell 1 is configured with configuration 2, and other serving cell 2 is configured with configuration 3, if HARQ-ACK is fed back in subframe 4, then serving cell 1 is downlink in subframe 4. If user equipment cannot determine HARQ-ACK codebook size for serving cell 1 unambiguously, then user equipment and eNB can differently decide the codebook size.

Also, for subframe 3 of configuration 0, there is no downlink subframe set associated with subframe 3, when one serving cell is uplink-downlink configuration 0 and another serving cell is another uplink-downlink configuration, such as configuration 1. So if HARQ-ACK feedback is in subframe 3, the user equipment conventionally cannot decide Kc value for serving cell with configuration 0.

In LTE Rel-10 carrier aggregation, all configured component carriers are configured with same time division duplex uplink/downlink configurations. So the bundle window sizes in Pcell and Scell are always same. In LTE Rel-11 inter-band time division duplex carrier aggregation, different PDSCH HARQ reference timing may be used with different time division duplex uplink/downlink configurations. The caused different bundle window sizes lead to the issue of uplink downlink assignment indicator indication.

For the first problem, one approach may be to an eNB-based method to always assume downlink subframes later than the uplink grant are all scheduled.

Regarding the second problem, there is nothing specified in Rel-10, because this was considered to be an error case with multiple uplink grants transmitted in the same downlink subframe in Rel-10 carrier aggregation and the handling was left to user equipment implementation. However, in Rel-11 carrier aggregation this is a normal case with multiple uplink grants transmitted in different downlink subframes. One approach may be that the uplink downlink assignment indicator value in the latest downlink subframe is used to determine the codebook size.

Certain embodiments are applicable to various kinds of communication systems including 3GPP LTE-Advanced Rel-11. More specifically, certain embodiments may be relevant to LTE time division duplex carrier aggregation (CA) enhancement with different time division duplex uplink/downlink configurations on different bands. The hybrid automatic repeat request (HARQ) timing reference for a secondary cell (Scell) can be different from primary cell (Pcell) time division duplex uplink/downlink configuration.

As a result, certain embodiments do not use the HARQ-ACK transmission methods defined in Rel-10, which assume Pcell timing for all configured carriers. Thus, certain embodiments avoid a first problem related to uplink downlink assignment indicator value setting at eNB and interpretation of uplink downlink assignment indicator at user equipment being different from one another. Likewise, certain embodiments avoid a second problem related to multiple uplink grant with different uplink downlink assignment indicator values. That is, if there are multiple PUSCH scheduled to the same uplink subframe with uplink grant transmitted from different downlink subframes, certain embodiments can permit the devices of the system to know how to use the multiple uplink downlink assignment indicator values to determine the codebook size for HARQ-ACK on PUSCH. Finally, certain embodiments relate to deciding Kc, which can be used to determine HARQ-ACK codebook size for feedback in PUCCH format 3 and PUCCH format 1b with channel selection.

Certain embodiments provide a HARQ-ACK codebook size determination scheme for the inter-band time division duplex carrier aggregation user equipment configured with different time division duplex uplink/downlink configurations on different bands. Assuming generic eNB implementation in setting uplink downlink assignment indicator values in case of multiple uplink grant scheduling PUSCH in the same uplink subframe, certain embodiments resolve the ambiguity of multiple uplink grants with different uplink downlink assignment indicator values. Various approaches, which can be standard related or eNB implementation related, can be used to avoid uplink downlink assignment indicator ambiguity, while providing a simple eNB implementation. Finally, the definition of Kc can be extended so that it can also be associated with downlink subframe.

If multiple PUSCHs are scheduled on a same uplink subframe from multiple serving cells and the PUSCH is adjusted based on a detected PDCCH with downlink control information format 0/4 and HARQ-ACK bits transmitted by PUSCH, W_{DAI}^{UL} can be set to different values in multiple uplink grants according to some other eNB implementation from the two approaches above, and the value in the uplink grant scheduling the PUSCH that carries the HARQ-ACK may be used to determine the codebook size.

Four approaches are described below to handle the uplink downlink assignment indicator. The first two are standard related, which means that they may impact how the user equipment interprets the uplink downlink assignment indicator. The last two are eNB implementation related, which means it may impact how the eNB should set the value for uplink downlink assignment indicator.

If user equipment is not configured to monitor PDCCH with carrier indicator field and PUCCH format 3 is configured for transmission of HARQ-ACK, then, first, when ACK/NACK bits are transmitted by PUSCH and the PUSCH is adjusted based on a detected PDCCH with downlink control information format 0/4, user equipment can assume B_{c}^{DL}=M_{c}, where B_{c}^{DL} is the number of downlink subframes for which the user equipment needs to feedback HARQ-ACK bits for the c-th serving cell, Mc is the number of elements in set Kc, and user equipment just ignores the uplink downlink assignment indicator in received downlink control information.

Moreover, second, when ACK/NACK bits are transmitted by PUSCH and the PUSCH is adjusted based on a detected PDCCH with downlink control information format 0/4, if uplink downlink assignment indicator ambiguity between eNB and user equipment occurs for determining HARQ-ACK codebook size in the uplink subframe, namely in the case of the problematic uplink subframes under each combination listed in Table 3, in that uplink subframe the HARQ-ACK codebook size is equal to M_{c}. In other words, the ACK/NACK codebook size may be determined as PUSCH transmission not adjusted based on a detected PDCCH with downlink control information format 0/4. In other uplink subframes without confusion for determining HARQ-ACK codebook size, uplink downlink assignment indicator can be used as usual, and the HARQ-ACK codebook size can be determined based on uplink downlink assignment indicator.

Third, when ACK/NACK bits are transmitted by PUSCH and the PUSCH is adjusted based on a detected PDCCH with downlink control information format 0/4, if downlink-reference uplink/downlink configuration of serving cell belongs to {0, 1, 2, 3, 4, 6}, the user equipment can generate ACK/NACK codebook on PUSCH according to an uplink downlink assignment indicator, and the eNB can calculate uplink downlink assignment indicator as W_{DAI}^{UL}=max(M_{c}). If downlink-reference uplink/downlink configuration of at least one configured serving cell belongs to {5}, the eNB can calculate uplink downlink assignment indicator as W_{DAI}^{UL}=1.

Fourth, when ACK/NACK bits are transmitted by PUSCH and the PUSCH is adjusted based on a detected PDCCH with DCI format 0/4, if DL-reference UL/DL configuration of serving cell belongs to {0, 1, 2, 3, 4, 6}, UE can generate ACK/NACK codebook on PUSCH according to UL DAI, UE calculates B_{c}^{DL}=min(W_{DAI}^{UL}+4|(U−W_{DAI}^{UL})/4|,M_{c}) with UL DAI. UL DAI value may only consider PDSCH transmission on own serving cell.

If PUCCH format 1b with channel selection is configured for transmission of HARQ-ACK, then first, when ACK/NACK bits are transmitted by PUSCH and the PUSCH is adjusted based on a detected PDCCH with downlink control information format 0/4, the user equipment can generate the HARQ-ACK bits as HARQ-ACK transmitted on the PUCCH.

Second, when ACK/NACK bits are transmitted by PUSCH and the PUSCH is adjusted based on a detected PDCCH with downlink control information format 0/4, if uplink downlink assignment indicator ambiguity between eNB and user equipment occurs for determining HARQ-ACK codebook size in the uplink subframe, namely the problematic uplink subframes under each combination listed in Table 3, in that uplink subframe, the user equipment can generate the HARQ-ACK bits as HARQ-ACK transmitted on the PUCCH. In other uplink subframes, uplink downlink assignment indicator can be used as usual, with HARQ-ACK bits mapping table selection based on uplink downlink assignment indicator.

Third, when ACK/NACK bits are transmitted by PUSCH and the PUSCH is adjusted based on a detected PDCCH with downlink control information format 0/4, if downlink-reference uplink/downlink configuration of serving cell belongs to {0, 1, 2, 3, 4, 6}, then the user equipment can generate ACK/NACK codebook on PUSCH according to uplink downlink assignment indicator. Meanwhile, the eNB can calculate uplink downlink assignment indicator as W_{DAI}^{UL}=max (M_{c}).

For the Kc definition, the set of downlink subframes, denoted as Kc, on serving cell c associated with uplink subframe n can include the downlink subframes n-k where kεK and K is determined according to the time division duplex uplink-downlink configuration which the PDSCH HARQ timing on serving cell c follows. In addition to conventional Kc definition, Kc can also cover a first case in which subframe n is uplink for one serving cell and is downlink for another serving cell. For this case, Kc which is associated with subframe n can be zero for serving cell with downlink subframe, correspondingly Mc, Mp, Ms associated with this serving cell can also be zero. Kc can also cover a second case in which there is no set of downlink subframe associated subframe n in a serving cell, Kc which is associated with subframe ti can be zero for this serving cell, correspondingly Mc, Mp, Ms associated with this serving cell can also be zero.

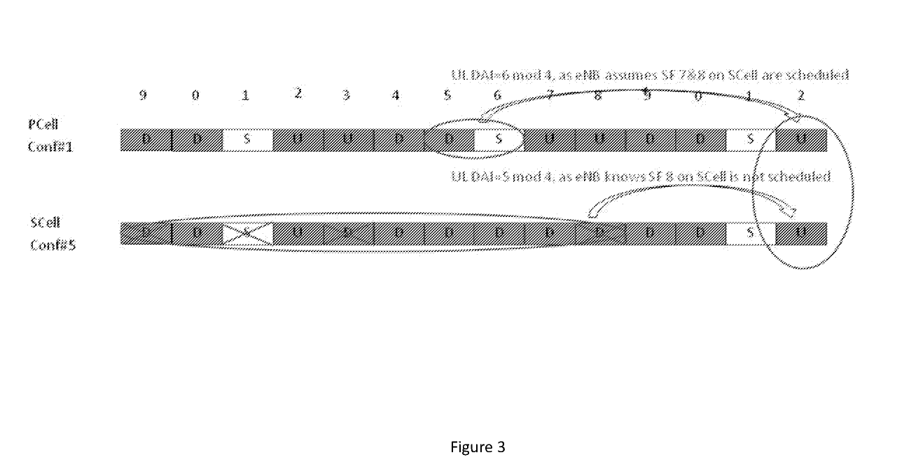

More particularly, FIG. 3 illustrates different uplink downlink assignment indicator values in case of multiple uplink grants scheduling multiple PUSCH. In the example in FIG. 3, subframe 5&6 on Pcell and subframe 0&4&5&6&7 on Scell may be scheduled, and the eNB may schedule PUSCH in subframe 2 on both Pcell and Scell with different uplink grant in subframe 6 on Pcell and subframe 8 on Scell, respectively. In this case, the eNB can set uplink downlink assignment indicator to 2, namely 6 mod 4, in subframe 6 as it cannot predict whether subframe 7&8 on Scell would be scheduled, so the eNB can assume that they are scheduled. Meanwhile, the eNB can set the uplink downlink assignment indicator to 1, namely 5 mod 4, in subframe 8 on Scell as it already knows PDSCH in subframe 8 on Scell is not scheduled. According to certain embodiments, if the HARQ-ACK is carried on PUSCH on Pcell, uplink downlink assignment indicator value of 2 can be used; while if HARQ-ACK is carried on PUSCH on Scell, uplink downlink assignment indicator value of 1 can be used. In other words, the HARQ-ACK on PUSCH may only be impacted by the uplink grant scheduling this PUSCH, and there may be no cross-impact from other uplink grants.

In LTE Rel-11 inter-band time division duplex carrier aggregation with different time division duplex uplink/downlink configurations on different bands, because different PDSCH HARQ reference timing may be used for different carriers, the bundle window size of Pcell and Scell may be different, which may lead to issues of uplink downlink assignment indicator when HARQ-ACK is transmitted on PUSCH adjusted by downlink control information format 0/4.

For a first approach, for the example shown in FIG. 2, if PUCCH format 3 is configured for transmission HARQ-ACK, HARQ-ACK feedback in subframe 2, Pcell BD_{c}^{DL}=M_{c}=2 and Scell B_{c}^{DL}=M_{c}=9, user equipment may not take received uplink downlink assignment indicator into account, then total 11 HARQ-ACK bits will be transmitted. HARQ-ACK feedback in subframe 3, Pcell B_{c}^{DL}=M_{c}=1 and Scell B_{c}^{DL}=M_{c}=0; HARQ-ACK feedback in subframe 7, Pcell B_{c}^{DL}=M_{c}=2 and Scell B_{c}^{DL}=M_{c}=0; HARQ-ACK feedback in subframe 8, Pcell B_{c}^{DL}=M_{c}=1 and Scell B_{c}^{DL}=M_{c}=0. For some downlink subframes that are not scheduled transmitting PDSCH, user equipment may feedback discontinuous transmission (DTX) corresponding to those subframes. For the subframe 2 which causes codebook size confusion between eNB and user equipment, Mc is used to determine HARQ-ACK bits instead of the uplink downlink assignment indicator. So there is no HARQ-ACK codebook size confusion between eNB and user equipment.

For a second approach, HARQ-ACK feedback in subframe 2 can cause codebook size confusion between eNB and user equipment, then HARQ-ACK bits can be generated as in the first approach, namely 11 HARQ-ACK bits. For HARQ-ACK feedback in subframe 3,7,8, there is no confusion between eNB and user equipment. Taking subframe 7 as an example, eNB can send uplink DAI=1, user equipment detects one PDSCH is transmitted on Pcell, so eNB should set W_{DAI}^{UL}=1, then for Pcell U=1 B_{c}^{DL}=min(W_{DAI}^{UL}+4|(U−W_{DAI}^{UL})/4|,M_{c}=min(1,2)=1; for Scell B_{c}^{DL}=min(W_{DAI}^{UL}+4|(U−W_{DAI}^{UL})/4|,M_{c}), Mc=0 then Scell B_{c}^{DL}=0. Comparing subframe 7 case with the first approach, the second approach can save transmitted bit overhead.

For a third approach, the user equipment still follows uplink downlink assignment indicator to determine the codebook size as is conventionally done. However, the eNB can set the value of uplink downlink assignment indicator according to W_{DAI}^{UL}=max(M_{c}). In the example in FIG. 2, uplink downlink assignment indicator can then be set to 1, namely 9 mod 4, and user equipment can determine codebook size according to Bĉ{DL}=min(W_{DAI}̂{UL}+4ceil((U−W_{DAI}̂{UL})/4), Mc) for each cell.

Based on the above described procedure, misunderstanding between eNB and user equipment on ACK/NACK codebook size determination can be eliminated, and implementation complexity can be decreased. As a result, degradation of downlink performance can be avoided.

Thus, certain embodiments may benefit from inter-band time division duplex carrier aggregation with different time division duplex uplink/downlink configurations on different bands. Moreover, certain embodiments may avoid a misunderstanding between eNB and user equipment on ACK/NACK codebook size determination. However, a possible uplink downlink assignment indicator may not be used in codebook size determination, which may be a difference from Rel.10.

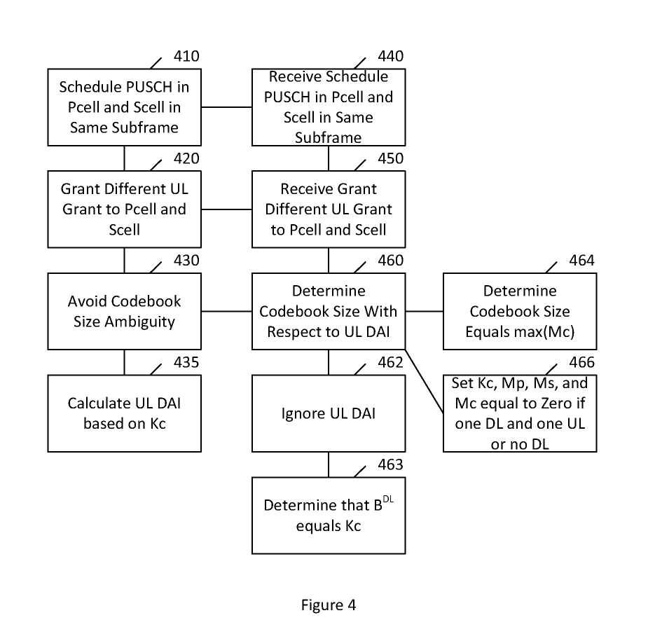

FIG. 4 illustrates methods according to certain embodiments. The methods of FIG. 4 may be performed by, for example, an eNode B and a user equipment, or similar devices. The method can include, at 410, scheduling physical uplink shared channel in at least one primary cell and at least one secondary cell in a same subframe. The method can also include, at 420, granting a different uplink grant to the at least one primary cell and the at least one secondary cell. The method can further include, at 430, avoiding codebook size confusion by handling uplink downlink assignment indicator ambiguity. The handling can include, at 435, calculating the uplink downlink assignment indicator based on a maximum number of elements in a downlink association set (Kc). The above steps may be performed by an eNode B. By contrast, the following steps may be performed by a user equipment.

The method can also include at 440, receiving a schedule for physical uplink shared channel in at least one primary cell and at least one secondary cell in a same subframe. The method can further include, at 450, receiving a different uplink grant to the at least one primary cell and the at least one secondary cell. The method can additionally include, at 460, determining a codebook size with respect to an uplink downlink assignment indicator. The determining is performed conditionally with respect to whether ambiguity between a user equipment and a base station occurs.

The determining can include a user equipment, at 462, ignoring the uplink downlink assignment indicator and, at 463, determining that a number of feedback hybrid automatic repeat request acknowledgement bits (B_{c}^{DL}) is equal to a maximum number of elements in a downlink association set (Kc). The determining can also include, at 464, determining that the codebook size equals a maximum number of elements in a downlink association set (max(Mc)).

The determining can further include, at 466, for a given subframe, determining that if the given subframe is uplink in a first serving cell and is downlink in a second serving cell, or if there is no set of downlink for the subframe, then a number of elements in a downlink association set for a primary cell and a secondary cell are each equal to zero.

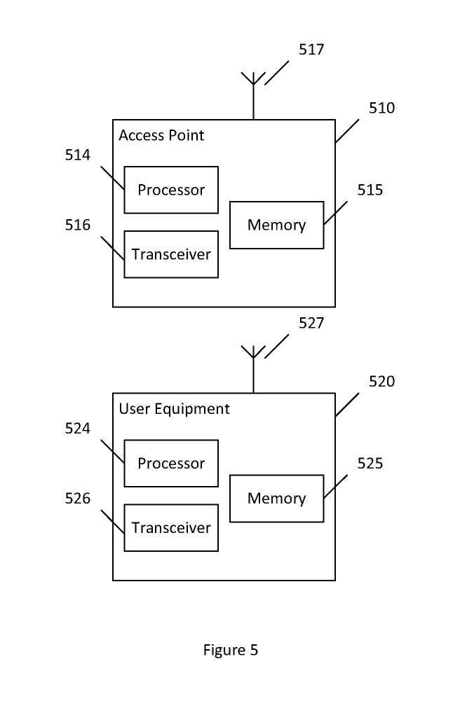

FIG. 5 illustrates a system according to certain embodiments of the invention. In one embodiment, a system may comprise several devices, such as, for example, access point 510 and UE 520. The system may comprise more than one UE 520 and more than one access point 510, although only one of each is shown for the purposes of illustration. The system may also involve only at least two UEs 520 or only at least two access points 510. An access point can be a base station, eNode B (eNB) or other network access element. Each of these devices may comprise at least one processor, respectively indicated as 514 and 524. At least one memory may be provided in each device, and indicated as 515 and 525, respectively. The memory may comprise computer program instructions or computer code contained therein. One or more transceiver 516 and 526 may be provided, and each device may also comprise an antenna, respectively illustrated as 517 and 527. Although only one antenna each is shown, many antennas and multiple antenna elements may be provided to each of the devices. Other configurations of these devices, for example, may be provided. For example, access point 510 and UE 520 may be additionally configured for wired communication, in addition to wireless communication, and in such a case antennas 517 and 527 may illustrate any form of communication hardware, without being limited to merely an antenna.

Transceivers 516 and 526 may each, independently, be a transmitter, a receiver, or both a transmitter and a receiver, or a unit or device that may be configured both for transmission and reception.

Processors 514 and 524 may be embodied by any computational or data processing device, such as a central processing unit (CPU), application specific integrated circuit (ASIC), or comparable device. The processors may be implemented as a single controller, or a plurality of controllers or processors.

Memories 515 and 525 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language.

The memory and the computer program instructions may be configured, with the processor for the particular device, to cause a hardware apparatus such as access point 510 and UE 520, to perform any of the processes described above or below (see, for example, FIGS. 4 and 6-10). Therefore, in certain embodiments, a non-transitory computer-readable medium may be encoded with computer instructions that, when executed in hardware, may perform a process such as one of the processes described herein. Alternatively, certain embodiments of the invention may be performed entirely in hardware.

Furthermore, although FIG. 5 illustrates a system including an access point 510 and a UE 520, embodiments of the invention may be applicable to other configurations, and configurations involving additional elements, as illustrated and discussed herein. For example, multiple user equipment devices and multiple access points may be present, or other nodes providing similar functionality, such as relays which may receive data from an access point and forward the data to a UE and may implement both functionality of the UE and functionality of the access point.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

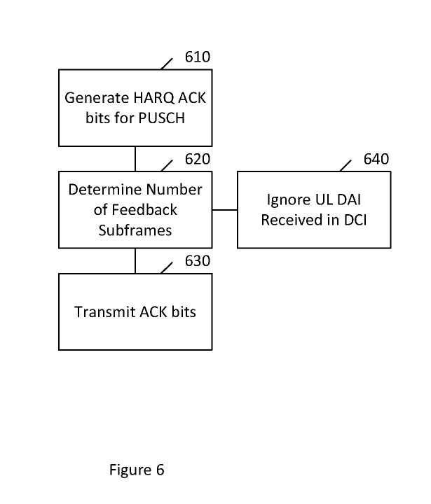

FIG. 6 illustrates another method according to certain embodiments. As shown in FIG. 6, a method can include, at 610, generating hybrid automatic-repeat request acknowledgment bits to be transmitted on a physical uplink shared channel scheduled by UL grant containing UL DAI. The method can also include, at 620, determining the number of subframes for which the user equipment needs to feed back hybrid automatic-repeat request acknowledgment bits for a given serving cell as the number of downlink elements in a downlink association set according to followed downlink reference uplink-downlink configuration for the given serving cell. The method can further include, at 630, transmitting the acknowledgement bits based on the determining. If a given subframe is uplink in a first serving cell and is downlink in a second serving cell, or if there is no set of downlink subframes associated with an uplink subframe in a second serving cell, then the number of the downlink elements in the downlink association set of a second serving cell can be equal to zero.

The method can additionally include, at 640, ignoring uplink downlink assignment indicators in received downlink control information.

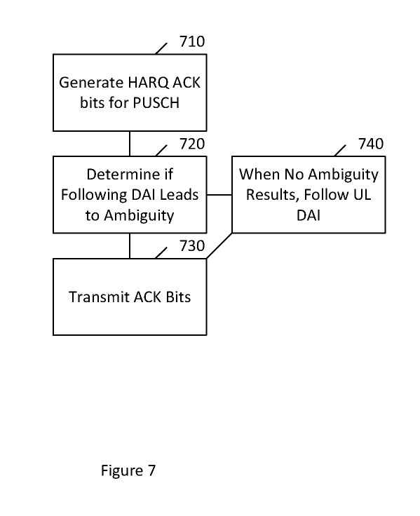

FIG. 7 illustrates a further method according to certain embodiments. As shown in FIG. 7, a method can include, at 710, generating hybrid automatic-repeat request acknowledgment bits to be transmitted on a physical uplink shared channel scheduled by UL grant containing UL DAI. The method can also include, at 720, determining whether the given subframe yields is ambiguous when uplink downlink assignment indicator is followed, wherein the determining the number of subframes UE needs to feedback hybrid automatic-repeat request acknowledgment bits as the number of the downlink elements in the downlink association set is performed when following the uplink downlink assignment indicator would yield ambiguity. The method can further include, at 730, transmitting the acknowledgement bits based on the determining. If a given subframe is uplink in a first serving cell and is downlink in a second serving cell, or if there is no set of downlink subframes associated with an uplink subframe in a second serving cell, then the number of the downlink elements in the downlink association set of a second serving cell can be equal to zero.

For a subframe that is not ambiguous when uplink downlink assignment indicator is followed, the method can include, at 740, following uplink downlink assignment indicator.

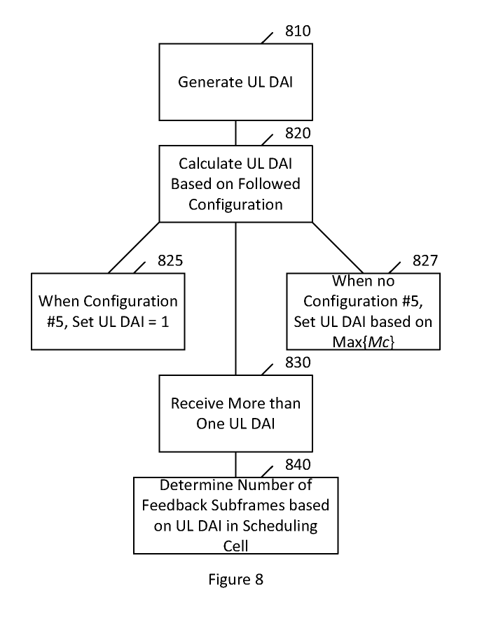

FIG. 8 illustrates an additional method according to certain embodiments. The method can include, at 810, generating an uplink downlink assignment indicator. The method can include, at 820, calculating the uplink downlink assignment indicator according to the number of downlink elements in a downlink association set according to followed downlink reference uplink-downlink configurations among serving cells.

When the downlink reference uplink-downlink configuration of one of the serving cells is uplink-downlink configuration number five, the calculating can include, at 825, setting the uplink downlink assignment indicator equal to 1.

When the downlink reference uplink-downlink configuration of none of the serving cells is uplink-downlink configuration number five, the calculating can include, at 827, setting the uplink downlink assignment indicator based on a maximum number of the number of downlink elements in a downlink association set among serving cells.

The method can further include, at 830, receiving more than one uplink downlink assignment indicator and, at 840, determining the number of subframes UE needs to feedback hybrid automatic-repeat request acknowledgment bits on serving cell based on the uplink downlink assignment indicator contained in the UL grant scheduling the physical uplink shared channel on which HARQ-ACK is carried.

If a given subframe is uplink in a first serving cell and is downlink in a second serving cell, or if there is no set of downlink subframes associated with an uplink subframe in a second serving cell, then the number of the downlink elements in the downlink association set of a second serving cell can be equal to zero.

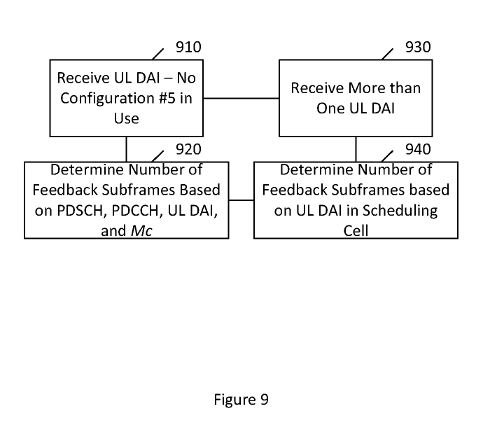

FIG. 9 illustrates another method according to certain embodiments. The method can include, at 910, receiving an uplink downlink assignment indicator, and the downlink reference uplink-downlink configuration of none of the serving cells is uplink-downlink configuration number five. The method can also include, at 920, determining the number of subframes UE needs to feedback hybrid automatic-repeat request acknowledgment bits on serving cell based on user equipment received physical downlink shared channel and SPS-releasing PDCCH, uplink downlink assignment indicator, and the number of the downlink elements in the downlink association set.

The method can further include, at 930, receiving more than one uplink downlink assignment indicator and, at 940, determining the number of subframes UE needs to feedback hybrid automatic-repeat request acknowledgment bits on serving cell based on the uplink downlink assignment indicator contained in the UL grant scheduling the physical uplink shared channel on which HARQ-ACK is carried.

If a given subframe is uplink in a first serving cell and is downlink in a second serving cell, or if there is no set of downlink subframes associated with an uplink subframe in a second serving cell, then the number of the downlink elements in the downlink association set of a second serving cell can be equal to zero.

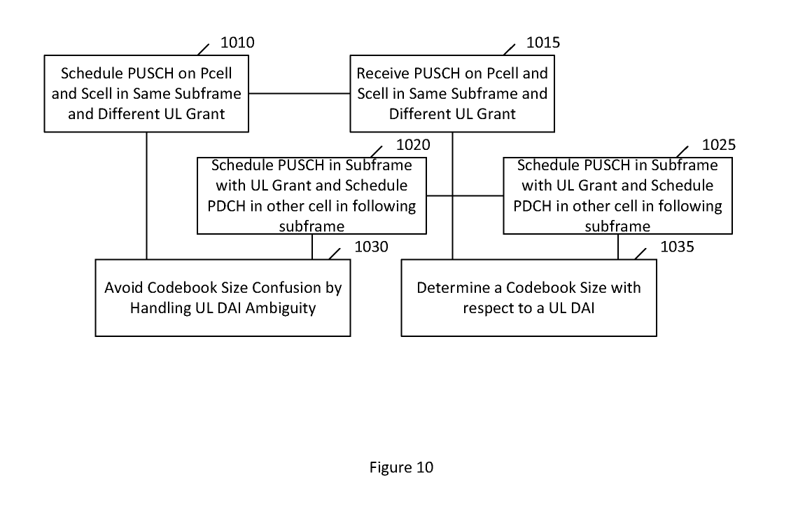

FIG. 10 illustrates a method according to certain embodiments. As shown in FIG. 10, the method can include, at 1010, scheduling physical uplink shared channel in at least one primary cell and at least one secondary cell in a same subframe and granting a different uplink grant to the at least one primary cell and the at least one secondary cell. Alternatively, the method can include, at 1020, scheduling physical uplink shared channel in at least one serving cell in a subframe with uplink grant and scheduling physical downlink channel in at least another serving cell in following subframe. The method can also include avoiding codebook size confusion by handling uplink downlink assignment indicator ambiguity.

The method can further include, at 1015, receiving a schedule for physical uplink shared channel in at least one primary cell and at least one secondary cell in a same subframe and receiving a different uplink grant to the at least one primary cell and the at least one secondary cell. Alternatively, the method can further include, at 1025, receiving physical uplink shared channel in at least one serving cell in a subframe with uplink grant and receiving physical uplink shared channel in at least another serving cell in following subframe. The method can also include, at 1035, determining a codebook size with respect to an uplink downlink assignment indicator.

### GLOSSARY

LTE Long term evolution
PUCCH Physical Uplink Control Channel
PUSCH Physical Uplink Shared Channel
DAI Downlink Assignment Indicator
DCI Downlink Control Information (DCI format 0/4 is uplink grant)
W_{DAI}^{UL} uplink downlink assignment indicator, otherwise known as downlink assignment indicator in uplink grant
M_{c} Size of set Kc
U the maximum value of U_{c} among all the configured serving cells
U_{c} the total number of received PDSCHs and PDCCH indicating downlink SPS release in subframe(s) n-k on the c-th serving cell, kεK.
Mp the number of elements in set Kc for the primary cell
Ms the number of elements in set Kc for the secondary cell
Kc the set of DL subframes on serving cell c associated with UL subframe n including the DL subframes n-k where kεK and K is determined according to the TDD UL-DL configuration which the PDSCH HARQ timing on serving cell c follows

1-37. (canceled)

38. An apparatus, comprising:
at least one processor; and
at least one memory including computer program code,
wherein the at least one memory and the computer program code are configured to, with the at least one processor, cause the apparatus at least to
generate hybrid automatic-repeat request acknowledgment bits to be transmitted on a physical uplink shared channel scheduled by uplink grant containing uplink downlink assignment indicator;
determine a number of subframes for which an user equipment needs to feed back the hybrid automatic-repeat request acknowledgment bits for a given serving cell as a number of downlink elements in a downlink association set according to followed downlink reference uplink-downlink configuration for the given serving cell; and
transmit the hybrid automatic-repeat request acknowledgement bits based on the determining to the user equipment.

39. The apparatus of claim 38, wherein if the given subframe is uplink in a first serving cell and is downlink in a second serving cell, or if there is no set of downlink subframes associated with an uplink subframe in a second serving cell, the at least one memory and the computer program code are configured to, with the at least one processor, cause the apparatus at least to then equal the number of the downlink elements in the downlink association set of the second serving cell to zero.

40. The apparatus of claim 38, wherein the at least one memory and the computer program code are configured to, with the at least one processor, cause the apparatus at least to ignore uplink downlink assignment indicators in received downlink control information.

41. An apparatus, comprising:
at least one processor; and
at least one memory including computer program code,
wherein the at least one memory and the computer program code are configured to, with the at least one processor, cause the apparatus at least to
generate hybrid automatic-repeat request acknowledgment bits to be transmitted on a physical uplink shared channel scheduled by uplink grant containing uplink downlink assignment indicator;
determine whether a given subframe with uplink downlink configuration is ambiguous when uplink downlink assignment indicator is followed, wherein determination of a number of subframes UE needs to feedback hybrid automatic-repeat request acknowledgment bits as a number of the downlink elements in the downlink association set is performed when following the uplink downlink assignment indicator would yield ambiguity; and
transmit the hybrid automatic-repeat request acknowledgement bits based on the determining to the user equipment.

42. The apparatus of claim 41, wherein the at least one memory and the computer program code are configured to, with the at least one processor, cause the apparatus at least to, for a subframe that is not ambiguous when uplink downlink assignment indicator is followed, follow uplink downlink assignment indicator.

43. The apparatus of claim 41, wherein if the given subframe is uplink in a first serving cell and is downlink in a second serving cell, or if there is no set of downlink subframes associated with an uplink subframe in a second serving cell, the at least one memory and the computer program code are configured to, with the at least one processor, cause the apparatus at least to then equal the number of the downlink elements in the downlink association set of the second serving cell to zero.

44. An apparatus, comprising:
at least one processor; and
at least one memory including computer program code,
wherein the at least one memory and the computer program code are configured to, with the at least one processor, cause the apparatus at least to
generate an uplink downlink assignment indicator; and
calculate the uplink downlink assignment indicator according to a number of downlink elements in a downlink association set according to followed downlink reference uplink-downlink configurations among serving cells.

45. The apparatus of claim 44, wherein when the downlink reference uplink-downlink configuration of one of the serving cells is uplink-downlink configuration number five, the at least one memory and the computer program code are configured to, with the at least one processor, cause the apparatus at least to set the uplink downlink assignment indicator equal to 1 in the calculation of the uplink downlink assignment indicator.

46. The apparatus of claim 44, wherein if the given subframe is uplink in a first serving cell and is downlink in a second serving cell, or if there is no set of downlink subframes associated with an uplink subframe in a second serving cell, the at least one memory and the computer program code are configured to, with the at least one processor, cause the apparatus at least to then equal the number of the downlink elements in the downlink association set of the second serving cell to zero.

47. The apparatus of claim 44, wherein the at least one memory and the computer program code are configured to, with the at least one processor, cause the apparatus at least to
receive more than one uplink downlink assignment indicator; and
determine a number of subframes an user equipment needs to feedback hybrid automatic-repeat request acknowledgment bits on serving cell based on the uplink downlink assignment indicator contained in the uplink grant scheduling the physical uplink shared channel on which automatic repeat request acknowledgment is carried.

48. The apparatus of claim 44, wherein when the downlink reference uplink-downlink configuration of none of the serving cells is uplink-downlink configuration number five, the at least one memory and the computer program code are configured to, with the at least one processor, cause the apparatus at least to set the uplink downlink assignment indicator based on a maximum number of the number of downlink elements in a downlink association set among serving cells in the calculation of the uplink downlink assignment indicator.

49. An apparatus, comprising:
at least one processor; and
at least one memory including computer program code,
wherein the at least one memory and the computer program code are configured to, with the at least one processor, cause the apparatus at least to
receive an uplink downlink assignment indicator, and the downlink reference uplink-downlink configuration of none of the serving cells is uplink-downlink configuration number five; and
determine a number of subframes UE needs to feedback hybrid automatic-repeat request acknowledgment bits on serving cell based on user equipment received physical downlink shared channel and SPS-releasing PDCCH, uplink downlink assignment indicator, and a number of the downlink elements in the downlink association set.

50. The apparatus of claim 49, wherein the at least one memory and the computer program code are configured to, with the at least one processor, cause the apparatus at least to
receive more than one uplink downlink assignment indicator; and
determine the number of subframes UE needs to feedback hybrid automatic-repeat request acknowledgment bits on serving cell based on the uplink downlink assignment indicator contained in the uplink grant scheduling the physical uplink shared channel on which automatic repeat request acknowledgment is carried.

51. The apparatus of claim 49, wherein if the given subframe is uplink in a first serving cell and is downlink in a second serving cell, or if there is no set of downlink subframes associated with an uplink subframe in a second serving cell, the at least one memory and the computer program code are configured to, with the at least one processor, cause the apparatus at least to then equal the number of the downlink elements in the downlink association set of the second serving cell to zero.
